(19) United States
(12) Patent Application Publication
(10) Pub. No.: US 2026/0251076 A1
(43) Pub. Date: Aug. 27, 2026

(54) COMBUSTION PRESSURE MEASUREMENT DEVICE AND COMBUSTION ENGINE INCLUDING THE SAME GAS TURBINE

(71) Applicant: DOOSAN ENERBILITY CO., LTD., Changwon (KR)

(72) Inventors: Dae Seok Jung, Gimhae (KR); Min Seok Han, Changwon (KR)

(21) Appl. No.: 19/534,948

(22) Filed: Feb. 10, 2026

(30) Foreign Application Priority Data
Feb. 24, 2025 (KR) 10-2025-0023427

(51) Int. Cl. F01D 21/00; G01L 19/04

(52) U.S. Cl. CPC F01D 21/003; G01L 19/04; F05D 2260/80

(57) ABSTRACT

A combustion pressure measurement device, a combustion engine including the same, and a gas turbine are provided. The combustion pressure measurement device measures combustion dynamic pressure in the combustion engine of the gas turbine, and includes a measurement tip unit disposed in a combustion space of the combustion engine and having a combustion air passage therein, and a measurement unit that measures combustion dynamic pressure of combustion air supplied through the combustion air passage of the measurement tip unit. The measurement tip unit has a plurality of cooling lines formed to reduce thermal damage to the measurement tip unit.

### CROSS REFERENCE TO RELATED APPLICATION

This application claims priority to Korean Patent Application No. 10-2025-0023427, filed February 24, 2025, the entire contents of which are incorporated herein by reference.

### BACKGROUND OF THE INVENTION

### Field of the Invention

The present disclosure relates to a combustion pressure measurement device, a combustion engine including the same, and a gas turbine. More particularly, the combustion pressure measurement device is installed at the combustion engine of the gas turbine and measures combustion dynamic pressure in the combustion engine.

### Description of the Related Art

Generally, a gas turbine is a rotary power engine that extracts energy from a flow of combustion air, consisting of a compressor, a turbine, and a combustor.

Specifically, the gas turbine is configured such that air compressed by the compressor is mixed with fuel in a combustion chamber, and the mixture is burned therein. The combustion generates high-temperature, high-pressure gas that expands, and the force of the expansion drives a turbine. It is important to monitor combustion conditions in the combustion chamber to ensure stability and reliability of the equipment.

Poor fuel supply to the combustion chamber can cause unstable combustion conditions. When the dynamic pressure in the combustion engine increases or resonates with engine components, it not only shortens the lifespan of the combustion engine but can also cause significant mechanical damage, which poses a serious risk.

Furthermore, combustion instability causes issues such as noise and vibration and a negative impact on the reliability of the combustion engine. These negative effects can also cause structural problems due to excessive heat transfer and high combustion dynamic pressure. Therefore, it is important to prevent combustion instability.

When the combustion dynamic pressure of the combustion engine is continuously measured, signs of combustion instability can be detected early and responded to. Furthermore, measured dynamic pressure can be effectively utilized during a tuning process that is provided to find the optimal operating conditions for the combustion engine. Therefore, dynamic pressure generated inside the combustion engine has conventionally been measured using sensors such as piezoelectric elements. As an example, a dynamic pressure sensor may be attached to the combustion engine chamber for measurement.

However, in the above-described conventional art, the heat transmitted from the combustion engine chamber during operation results in high-temperature, high-pressure operating conditions. This causes damage to the sensors, thereby shortening the replacement cycle of expensive high-temperature sensors and increasing maintenance costs. Furthermore, replacement during operation is impossible when sensors are broken, leading to a problem of deteriorated reliability of dynamic pressure measurement.

To eliminate the above-described issues, a pressure measurement probe is produced and a device having an additional sensing line to measure dynamic pressure in the combustion engine has been used. This device is configured to insert a tubular measurement tip into a combustion engine casing to extract internal dynamic pressure outward for measurement.

As a related art, Korean Patent No. 10-1219243 discloses the combustion pressure measurement device. The combustion pressure measurement device includes a waveguide connected to the combustion engine for extracting combustion dynamic pressure, a measurement unit connected to the waveguide for measuring combustion dynamic pressure, converting it into an electrical signal, and transmitting it to a data storage unit, a damping coil connected to the waveguide and attenuating combustion dynamic pressure, and a purge unit for periodically purging condensate generated in the waveguide and the damping coil.

That is, the related art is characterized to enable measurement of combustion dynamic pressure using a low-temperature dynamic pressure sensor by being configured to periodically purge condensate generated by combustion and compensate the measured combustion dynamic pressure value according to the length of the waveguide and the frequency of the combustion dynamic pressure. However, since an end of the waveguide connected to the combustion engine to extract combustion dynamic pressure is exposed to a high-temperature portion of the combustion engine, the risk of failure or deformation is increased and the reliability of the dynamic pressure measurement is deteriorated, which is problematic.

### SUMMARY OF THE INVENTION

Accordingly, the present disclosure has been made in view of the above problems occurring in the related art, and an objective of the present disclosure is to provide a combustion pressure measurement device, a combustion engine including the same, and a gas turbine, the combustion pressure measurement device being capable of measuring combustion dynamic pressure in a combustion engine using a measurement tip unit and a measurement unit by being installed at the combustion engine of a gas turbine, and preventing an end of the measurement tip unit from melting due to high temperature in the combustion engine with a plurality of cooling lines formed at the measurement tip unit.

In order to achieve the above objective, according to the present disclosure, there is provided a combustion pressure measurement device configured to measure combustion dynamic pressure in a combustion engine of a gas turbine, the combustion pressure measurement device including: a measurement tip unit disposed in a combustion space of the combustion engine and including a combustion air passage therein; and a measurement unit including a pressure sensor and configured to measure combustion dynamic pressure of combustion air supplied through the combustion air passage of the measurement tip unit, wherein the measurement tip unit may include a plurality of cooling lines to reduce thermal damage to the measurement tip unit.

In the combustion pressure measurement device according to the present disclosure, the measurement tip unit may include: a measurement tip tube including a first end disposed in the combustion space, a second end disposed outside a nozzle casing of the combustion engine, and the combustion air passage formed therein; a locational restriction member provided outside the first end of the measurement tip tube and restricting a location of the first end of the measurement tip tube inserted into the combustion engine; and a support member coupled to an outer portion of the measurement tip tube while being spaced apart from the locational restriction member, and configured to support the measurement tip tube while being in close contact with the nozzle casing, wherein the plurality of cooling lines may be formed at the locational restriction member.

The measurement tip tube may be a hollow tube, the locational restriction member may have a cylindrical shape, an end of the locational restriction member may be in close contact with a liner of the combustion engine, and the end may include an inclined end inclined from a circumferential surface of the locational restriction member toward the measurement tip tube, and the plurality of cooling lines having an inward concave shape may be formed on the circumferential surface of the locational restriction member and the inclined end of the locational restriction member.

The circumferential surface of the locational restriction member may include a first section formed at an upstream side with respect to a flow direction of the combustion air and a second section formed at a downstream side with respect to the flow direction of the combustion air, and the plurality of cooling lines may be formed within the second section.

The first section may include a central angle between 31 and 95 degrees based on a center of the locational restriction member.

The second section may include six cooling lines, and each cooling line may have a semicircular shape, and a radius of each cooling line may be equal to or greater than 2.0 mm and less than or equal to 3.0 mm.

Each cooling line may be formed by extending from the locational restriction member to the inclined end, and the cooling lines formed at the inclined end may have an angle between 6 and 22 degrees with respect to a shaft direction.

An angle between one cooling line and an adjacent cooling line of the six cooling lines formed within the second section may be an angle selected from a range between 35° and 40°.

The cooling lines may be coated with chromium carbide that may be a compound consisting of chromium and carbon, and the locational restriction member may be made of a heat-resistant material.

In the combustion pressure measurement device according to the present disclosure may further include: a damping unit connecting the measurement tip unit and the measurement unit to each other, and configured to attenuate combustion dynamic pressure of combustion air supplied to the measurement unit; and a data processing unit connected to the measurement unit, and configured to analyze data of the combustion dynamic pressure measured by the measurement unit, determining operational conditions of the combustion engine, and checking abnormal conditions thereof.

Furthermore, according to the present disclosure, there is provided a combustion engine configured to mix compressed air supplied from a compressor of a gas turbine with fuel and combust the compressed air and the fuel, and to supply the generated combustion air to a turbine of the gas turbine, the combustion engine including: a nozzle casing; a liner connected to a turbine-side end portion of the nozzle casing, and including a combustion space formed therein and combusting the mixture of the fuel and the compressed air; a transition piece connected to a turbine-side end portion of the liner, and configured to supply combustion air generated in the combustion space to the turbine; and a nozzle assembly installed inside the nozzle casing, and configured to inject the fuel and the compressed air into the combustion space, wherein the combustion engine may include a combustion pressure measurement device configured to measure combustion dynamic pressure in the combustion engine, wherein the combustion pressure measurement device may include: a measurement tip unit disposed in the combustion space of the combustion engine, and including a combustion air passage formed therein; and a measurement unit including a pressure sensor and configured to measure combustion dynamic pressure of combustion air supplied through the combustion air passage of the measurement tip unit, wherein the measurement tip unit may include a plurality of cooling lines to reduce thermal damage to the measurement tip unit.

Furthermore, according to the present disclosure, there is provided a gas turbine including: a compressor configured to compress air introduced from an external space; a combustion engine configured to mix compressed air supplied from the compressor with fuel and to combust the compressed air and the fuel; and a turbine configured to allow combustion air supplied from the combustion engine to pass through the inner portion thereof to generate power for electric power generation, wherein the combustion engine includes: a nozzle casing; a liner connected to a turbine-side end portion of the nozzle casing, and including a combustion space formed therein and combusting the mixture of the fuel and the compressed air; a transition piece connected to a turbine-side end portion of the liner, and configured to supply combustion air generated in the combustion space to the turbine; and a nozzle assembly installed inside the nozzle casing, and injecting the fuel and the compressed air into the combustion space, wherein the combustion engine may include a combustion pressure measurement device configured to measure combustion dynamic pressure in the combustion engine, wherein the combustion pressure measurement device may include: a measurement tip unit disposed in the combustion space of the combustion engine, and including a combustion air passage formed therein; and a measurement unit including a pressure sensor and configured to measure combustion dynamic pressure of combustion air supplied through the combustion air passage of the measurement tip unit, wherein the measurement tip unit may include a plurality of cooling lines to reduce thermal damage to the measurement tip unit.

According to the present disclosure, with the combustion pressure measurement device, the combustion engine including the same, and the gas turbine, the combustion dynamic pressure in the combustion engine can be measured using the measurement tip unit and the measurement unit, and the plurality of cooling lines formed at the measurement tip unit can prevent an end of the measurement tip unit from melting due to high temperature of the combustion engine.

### BRIEF DESCRIPTION OF THE DRAWINGS

FIG. 1 is a schematic view showing a gas turbine according to the present disclosure.

FIG. 2 is a cut-perspective view of the combustion engine shown in FIG. 1.

FIG. 3 is a schematic view showing a combustion pressure measurement device installed in the combustion engine shown in FIG. 2, and measuring combustion dynamic pressure in the combustion engine.

FIG. 4 is a schematic view showing the installation condition of the combustion pressure measurement device shown in FIG. 3 installed in the combustion engine.

FIG. 5 is an enlarged view showing the measurement tip unit shown in FIG. 4.

FIG. 6 is a side view of the measurement tip unit shown in FIG. 5.

FIG. 7 is a schematic view showing the combustion pressure measurement device with a modified damping unit.

### DETAILED DESCRIPTION OF THE DISCLOSURE

Hereinbelow, an exemplary embodiment of the present disclosure will be described in detail with reference to the accompanying drawings. Prior to the description, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present disclosure.

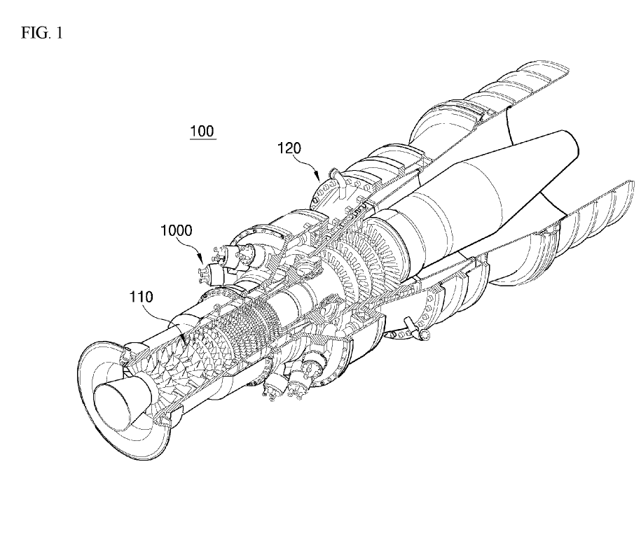

Referring to FIG. 1, a gas turbine 100 includes a compressor 110, a combustion engine 1000, and a turbine 120. Based on a flow direction of gas (compressed air or combustion air), the compressor 110 is disposed at an upstream location in the gas turbine 100, and the turbine 120 is disposed at a downstream location therein. The combustion engine 1000 is disposed between the compressor 110 and the turbine 120.

The compressor 110 includes a compressor vane and a compressor rotor in a compressor casing, and the turbine 120 includes a turbine vane and a turbine rotor in a turbine casing. The compressor vane and the compressor rotor are disposed in multiple stages in a flow direction of compressed air, and the turbine vane and the turbine rotor are also disposed in multiple stages in a flow direction of combustion air. At this point, the compressor 110 is formed with an inner space reduced in a direction from a front stage to a rear stage to compress sucked air. On the other hand, the turbine 120 has a structure in which an inner space becomes larger in a direction from the front stage to the rear stage to allow combustion air supplied by the combustion engine 1000 to expand.

Meanwhile, a torque member is disposed between the compressor rotor located at the rearmost end portion of the compressor 110 and the turbine rotor located at the foremost end portion of the turbine 120, as a torque transmission member to transmit rotational torque generated by the turbine 120 to the compressor 110. The torque member may consist of a plurality of torque tube discs arranged in three stages, but is not limited thereto. The torque member may include a plurality of torque tube discs arranged in four or more stages or two or less stages.

The compressor rotor includes a compressor disc and a compressor blade. A plurality of compressor discs (e.g., 14 sheets) are provided in the compressor casing, and each of the compressor discs is fastened with a tie rod so as not to prevent separation thereof in a shaft direction. More specifically, each of the compressor discs is aligned in the shaft direction with the tie rod passing through a central portion thereof. Furthermore, one compressor disc and an adjacent compressor disc of the compressor discs are disposed so as not to be rotated relatively to each other, with opposite surfaces thereof compressed by the tie rod.

A plurality of compressor blades is radially coupled to an outer circumferential surface of each of the compressor discs. Furthermore, based on the same stage, a plurality of compressor vanes installed in a ring shape on an inner circumferential surface of the compressor casing are disposed between the compressor blades. The compressor vanes remain secured without being rotated, unlike the compressor discs, and serve to align a flow of compressed air passing through the compressor blades and guide the compressed air to the compressor blades located at the downstream location. At this point, the compressor casing and the compressor vanes may be defined as a comprehensive name, i.e., a compressor stator, to distinguish them from the compressor rotor.

The compressor stator includes a compressor entrance scroll strut in addition to the compressor casing and the compressor vanes. The compressor entrance scroll strut is connected to a front end of the compressor casing and guides external air to an entrance of the compressor casing. Meanwhile, among the compressor vanes, the compressor vane located at the foremost end refers to an inlet guide vane. The inlet guide vane guides air introduced into the compressor casing to the compressor blades and the compressor vane arranged at a rear end.

The tie rod is disposed to pass through the central portion of the plurality of compressor discs and the central portion of the turbine discs, which will be described below. A first end portion of the tie rod is fastened to an inner portion of the compressor disc located at the foremost end portion of the compressor 110, and a second end portion thereof is fastened by a fixing nut.

The shape of the tie rod may be changed in various structures in response to the gas turbine, and is not necessarily limited to the shape shown in FIG. 1. In other words, as shown in the drawings, one tie rod may be shaped to pass through the central portion of the compressor discs and the central portion of the turbine discs, and a plurality of tie rods may be arranged circumferentially, and a combination thereof is also possible.

Not shown in the drawings, the compressor 110 of the gas turbine 100 may include a deswirler, serving as a guiding vane installed to adjust a flow angle of a fluid, which enters an entrance of the combustion engine 1000 after a pressure of the fluid is increased, to a designed flow angle.

High-temperature, high-pressure combustion air discharged from the combustion engine 1000 is supplied to the above-described turbine 120. The high-temperature, high-pressure combustion air supplied to the turbine 120 expands by passing the inner portion of the turbine 120. This expansion provides impulsive and reaction force to a turbine blade, which will be described later to generate rotating torque. The rotating torque produced as described above passes through the above-described torque member and is transmitted to the compressor 110, and a portion exceeding the power required to drive the compressor 110 is used to drive a generator, etc.

The turbine 120 is fundamentally similar to a structure of the compressor 110. That is, the turbine 120 also includes a plurality of turbine rotors similar to the compressor rotor of the compressor 110. Therefore, the turbine rotor also includes the turbine discs, and a plurality of turbine blades arranged radially. Based on the same stage, a plurality of turbine vanes are provided between the turbine blades in a ring shape on the turbine casing, and the turbine vanes guide a flow direction of combustion air passing through the turbine blades. At this point, the turbine casing and the turbine vanes may also be defined as a comprehensive name, i.e., a turbine stator, to distinguish them from the turbine rotor.

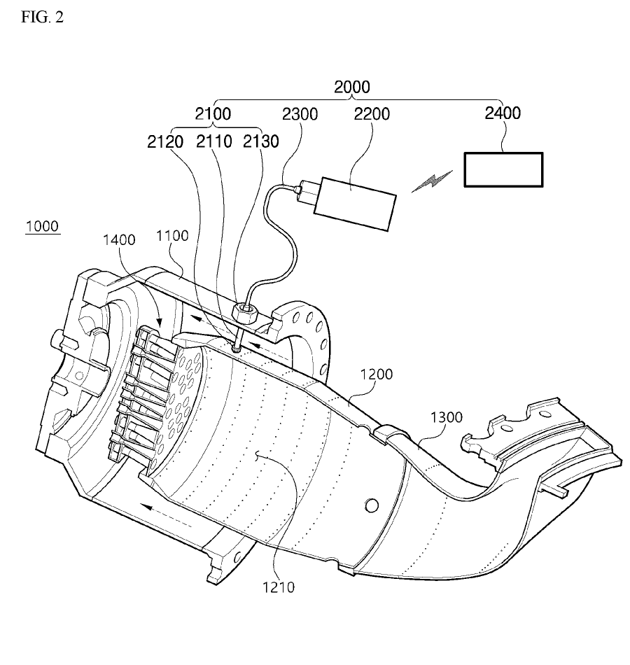

As shown in FIGS. 1 and 2, according to the present disclosure, the combustion engine 1000 includes a nozzle casing 1100, a liner 1200, a transition piece 1300, and a nozzle assembly 1400. The nozzle casing 1100 has a hollow cylindrical shape and receives fuel from the external part. The nozzle casing 1100 includes a casing head (not shown), and the casing head (not shown) covers the nozzle casing 1100 from a front space of the nozzle casing 1100. The liner 1200 is disposed inside the nozzle casing 1100 and has a hollow cylindrical shape. Furthermore, compressed air flows from a rear space toward a front space between the liner 1200 and the nozzle casing 1100, and fuel and compressed air are injected inward from the front portion.

Furthermore, as a mixture of the fuel and the compressed air injected into the liner 1200 is burned, high-pressure, high-temperature flames and combustion air are generated. At this point, a space where combustion is performed in the liner 1200 is the combustion space 1210. A liner head (not shown) is installed at a front portion of the liner 1200, and the liner head (not shown) mixes supplied fuel and compressed air and supplies the mixture thereof into the liner 1200.

An end of the liner 1200 at the turbine 120 is connected to the transition piece 1300, and the transition piece 1300 supplies combustion air generated from the combustion chamber 1210 to the turbine 120. The transition piece 1300 includes a transition piece ring-shaped flow passage formed to surround an internal space of the transition piece 1300, and compressed air flowing along the transition piece ring-shaped flow passage cools an outer wall portion to prevent damage due to high temperature of combustion air.

The internal space of the nozzle casing 1100, more specifically, the liner head (not shown) includes the nozzle assembly 1400 installed thereto. The nozzle assembly 1400 mixes fuel and compressed air and injects the mixture into the combustion space 1210.

The nozzle assembly 1400 is arranged in a structure in which one nozzle group is arranged at a central portion of the nozzle casing 1100 and a plurality of nozzle groups are arranged to surround the central nozzle group at the radially outer portion.

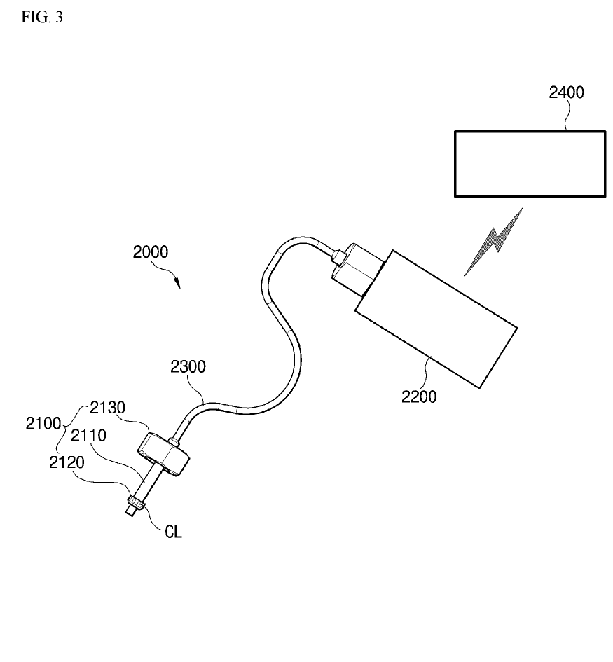

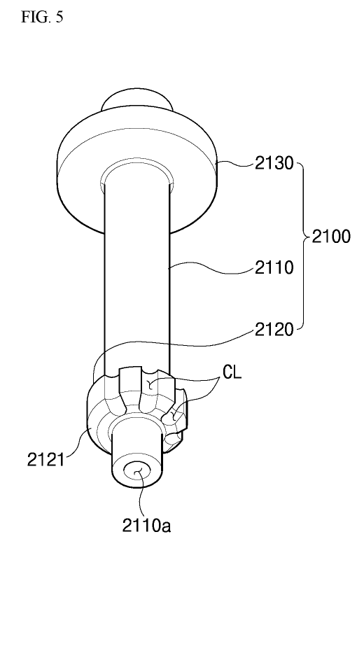

Referring to FIGS. 2 to 6, the combustion engine 1000 includes a combustion pressure measurement device 2000 configured to measure combustion dynamic pressure in the combustion engine 1000, and the combustion pressure measurement device 2000 includes a measurement tip unit 2100 and a measurement unit 2200 and may further include a damping unit 2300 and a data processing unit 2400.

Referring to FIGS. 2, 3 and 5, the measurement tip unit 2100 includes a first end disposed in the combustion space 1210 of the combustion engine 1000, and a combustion air passage 2110a is formed in the measurement tip unit 2100 so that combustion air in the combustion space 1210 flows therein. The measurement unit 2200 is connected to the measurement tip unit 2100, and the measurement unit 2200 includes a pressure sensor and is configured to measure the combustion dynamic pressure of combustion air supplied through the combustion air passage 2110a of the measurement tip unit 2100.

The measurement tip unit 2100, of which a first end is disposed in the combustion space 1210, includes a measurement tip tube 2110, a locational restriction member 2120, and a support member 2130. The measurement tip unit 2100 includes a plurality of cooling lines CL configured to reduce thermal damage to the measurement tip unit 2100 due to a high temperature of the combustion engine 1000.

The measurement tip tube 2110 is a hollow tube, and includes a first end disposed in the combustion space 1210 and a second end disposed outside the nozzle casing 1100. The combustion air passage 2110a is formed in the measurement tip tube 2110.

The locational restriction member 2120 is provided outside an end of the measurement tip tube 2110, and is configured to restrict a location of an end of the measurement tip tube 2110 when inserted into the combustion engine 1000. The locational restriction member 2120 has a cylindrical shape, and the plurality of cooling lines CL are formed on the locational restriction member 2120.

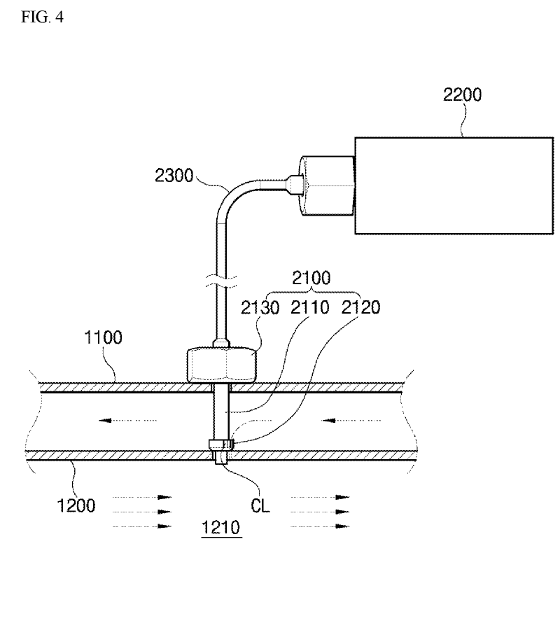

Referring to FIGS. 2 and 4, the support member 2130 is provided outside the measurement tip tube 2110 while being spaced apart from the locational restriction member 2120, and the support member 2130 is coupled to an outer portion of the measurement tip tube 2110 and supports the measurement tip tube 2110 while the measurement tip tube 2110 is in close contact with the nozzle casing 1100.

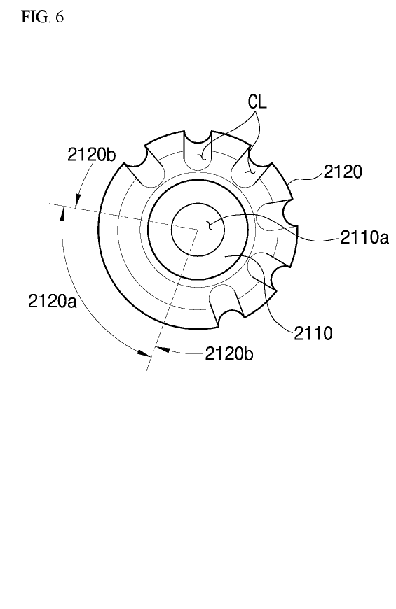

Referring to FIGS. 4 and 6, an end of the locational restriction member 2120 in close contact with the liner 1200 of the combustion engine 1000 includes an inclined end 2121. The inclined end 2121 is formed to be inclined from a circumferential surface of the locational restriction member 2120 toward the measurement tip tube 2110, and the plurality of cooling lines CL are formed in an inward concave shape on the circumferential surface of the locational restriction member 2120 and the inclined end 2121.

The circumferential surface of the locational restriction member 2120 includes a first section 2120a and a second section 2120b. The first section 2120a is formed on the circumferential surface of the locational restriction member 2120 at an upstream side with respect to a flow direction of the combustion air while the locational restriction member 2120 is in close contact with the liner 1200, and the second section 2120b is formed on the circumferential surface of the locational restriction member 2120 at a downstream side with respect to the flow direction of the combustion air, and the plurality of cooling lines CL are preferably formed within the second section 2120b.

The first section 2120a formed on the circumferential surface of the locational restriction member 2120 has a central angle between 31 and 95 degrees based on the center of the locational restriction member 2120, and the second section 2120b may include six cooling lines CL.

When a central angle of the first section 2120a based on the center of the locational restriction member 2120 is less than 31 degrees, there is an issue such as an increased possibility of acquiring error data due to interference with cooling air, and when a central angle of the first section 2120a based on the center of the locational restriction member 2120 is greater than 95 degrees, there is an issue of insufficient cooling.

Each of the six cooling lines CL formed within the second section 2120b has a semicircular shape, and the radius of each cooling line CL is preferably equal to or greater than 2.0 mm and less than or equal to 3.0 mm.

The cooling lines CL are coated with chromium carbide that is a compound consisting of chromium and carbon, and the locational restriction member 2120 is preferably made of a heat-resistant material. As the cooling lines CL are coated with chromium carbide, the durability of the cooling lines CL can be improved in a high-temperature, high-wear, and high-corrosion environment.

The locational restriction member 2120 is made of a heat-resistant material, and the plurality of cooling lines CL is formed in the second section 2120b of the locational restriction member 2120. As the plurality of cooling lines CL is formed only at the downstream section of combustion air, vortex formation is suppressed, thereby enhancing the reliability of dynamic pressure. Air flowing into the plurality of cooling lines CL is used to cool the locational restriction member 2120 and an end of the measurement tip tube 2110 inserted into the liner 1200, thereby preventing them from melting by a high temperature of the combustion engine.

The cooling lines CL are formed by extending from the locational restriction member 2120 to the inclined end 2121, and the cooling lines CL formed at the inclined end 2121 are preferably inclined at an angle between 6 degrees and 22 degrees with respect to the shaft direction.

When the cooling lines CL are inclined at an angle of less than 6 degrees with respect to the shaft direction, there is an issue such as the possibility of obtaining incorrect information, and when the cooling lines CL are inclined at an angle of greater than 22 degrees, there is an issue such as a reduction in cooling fluid amount.

An angle between one cooling line and an adjacent cooling line of the six cooling lines CL formed within the second section 2120b of the locational restriction member 2120 is preferably an angle selected from a range between 35 degrees and 40 degrees.

An angle between one cooling line and an adjacent cooling line of the six cooling lines CL formed in the second section 2120b is between 35 degrees and 40 degrees, so that the six cooling lines CL may be arranged within the second section 2120b while being spaced apart from each other at uniform angles.

Referring to FIGS. 2 to 4, the measurement tip unit 2100 and the measurement unit 2200 are connected to each other via the damping unit 2300, and the damping unit 2300 is configured to attenuate combustion dynamic pressure of combustion air supplied to the measurement unit 2200.

The measurement unit 2200 is connected to the data processing unit 2400, and the data processing unit 2400 analyzes combustion dynamic pressure data measured by the measurement unit 2200 and determines operational conditions of the combustion engine 1000 and checks abnormal conditions.

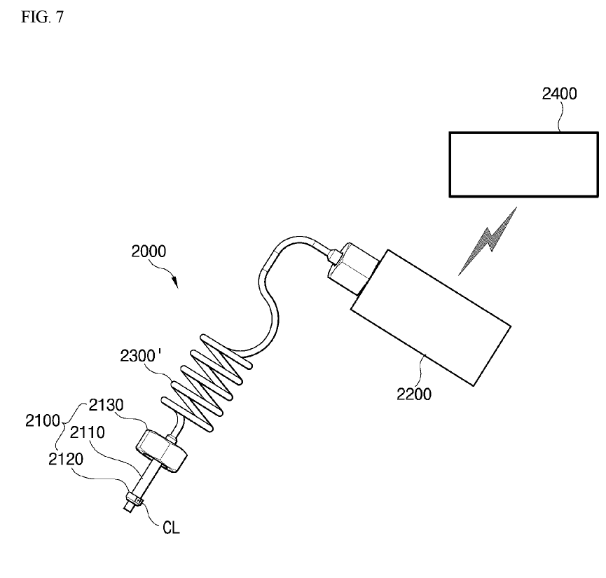

Referring to FIG. 7, the measurement tip unit 2100 and the measurement unit 2200 may be connected to each other via a damping unit 2300' having a coil shape, and the coil shape of the damping unit 2300' may allow the combustion air supplied to the measurement unit 2200 to efficiently lose internal moisture of the combustion air. Efficient removal of internal moisture by the damping unit 2300' may enable precise measurement of combustion dynamic pressure.

Therefore, the measurement tip unit 2100 and the measurement unit 2200 may be used to measure combustion dynamic pressure in the combustion engine 1000, and the plurality of cooling lines CL are formed in the measurement tip unit 2100, thereby preventing an end of the measurement tip unit 2100 from melting due to high temperature of the combustion engine 1000.

Although the preferred embodiments of the present disclosure have been disclosed for illustrative purposes with reference to the drawings, those skilled in the art will appreciate that various modifications, additions and substitutions are possible, without departing from the scope and spirit of the disclosure as defined in the accompanying claims. Therefore, the patent right of the present disclosure should be defined by the scope and spirit of the present disclosure as defined in the accompanying claims.

What is claimed is:

1. A combustion pressure measurement device configured to measure combustion dynamic pressure in a combustion engine of a gas turbine, the combustion pressure measurement device comprising:
a measurement tip unit disposed in a combustion space of the combustion engine and comprising a combustion air passage therein; and
a measurement unit including a pressure sensor and configured to measure the combustion dynamic pressure of combustion air supplied through the combustion air passage of the measurement tip unit,
wherein the measurement tip unit comprises a plurality of cooling lines to reduce thermal damage to the measurement tip unit.

2. The combustion pressure measurement device of claim 1, wherein the measurement tip unit comprises:
a measurement tip tube comprising a first end disposed in the combustion space, a second end disposed outside a nozzle casing of the combustion engine, and the combustion air passage formed therein;
a locational restriction member provided outside the first end of the measurement tip tube and restricting a location of the first end of the measurement tip tube inserted into the combustion engine; and
a support member coupled to an outer portion of the measurement tip tube while being spaced apart from the locational restriction member, and configured to support the measurement tip tube while being in close contact with the nozzle casing,
wherein the plurality of cooling lines are formed at the locational restriction member.

3. The combustion pressure measurement device of claim 2, wherein the measurement tip tube is a hollow tube,
the locational restriction member has a cylindrical shape,
an end of the locational restriction member is in close contact with a liner of the combustion engine, and the end includes an inclined end inclined from a circumferential surface of the locational restriction member toward the measurement tip tube, and
the plurality of cooling lines having an inward concave shape are formed on the circumferential surface of the locational restriction member and the inclined end of the locational restriction member.

4. The combustion pressure measurement device of claim 3, wherein the circumferential surface of the locational restriction member comprises a first section formed at an upstream side with respect to a flow direction of the combustion air and a second section formed at a downstream side with respect to the flow direction of the combustion air, and
the plurality of cooling lines are formed within the second section.

5. The combustion pressure measurement device of claim 4, wherein the first section comprises a central angle between 31 and 95 degrees based on a center of the locational restriction member.

6. The combustion pressure measurement device of claim 5, wherein the second section includes six cooling lines, and
each cooling line has a semicircular shape, and a radius of each cooling line is equal to or greater than 2.0 mm and less than or equal to 3.0 mm.

7. The combustion pressure measurement device of claim 6, wherein each cooling line is formed by extending from the locational restriction member to the inclined end, and the cooling lines formed at the inclined end have an angle between 6 and 22 degrees with respect to a shaft direction.

8. The combustion pressure measurement device of claim 6, wherein an angle between one cooling line and an adjacent cooling line of the six cooling lines formed within the second section is between 35 degrees and 40 degrees.

9. The combustion pressure measurement device of claim 8, wherein the cooling lines are coated with chromium carbide that is a compound consisting of chromium and carbon, and
the locational restriction member is made of a heat-resistant material.

10. The combustion pressure measurement device of claim 1, further comprising:
a damping unit connecting the measurement tip unit and the measurement unit to each other, and configured to attenuate combustion dynamic pressure of combustion air supplied to the measurement unit.

11. The combustion pressure measurement device of claim 10, further comprising:
a data processing unit connected to the measurement unit, and configured to analyze data of the combustion dynamic pressure measured by the measurement unit, determine operational conditions of the combustion engine, and check abnormal conditions thereof.

12. A combustion engine configured to mix compressed air supplied from a compressor of a gas turbine with fuel and combust the compressed air and the fuel, and to supply the generated combustion air to a turbine of the gas turbine, the combustion engine comprising:
a nozzle casing;
a liner connected to a turbine-side end portion of the nozzle casing, and comprising a combustion space formed therein and combusting the mixture of the fuel and the compressed air;
a transition piece connected to a turbine-side end portion of the liner, and configured to supply combustion air generated in the combustion space to the turbine; and
a nozzle assembly installed inside the nozzle casing, and configured to inject the fuel and the compressed air into the combustion space,
wherein the combustion engine comprises a combustion pressure measurement device configured to measure combustion dynamic pressure in the combustion engine,
wherein the combustion pressure measurement device comprises:
a measurement tip unit disposed in the combustion space of the combustion engine, and comprising a combustion air passage formed therein; and
a measurement unit including a pressure sensor and configured to measure combustion dynamic pressure of combustion air supplied through the combustion air passage of the measurement tip unit,
wherein the measurement tip unit comprises a plurality of cooling lines to reduce thermal damage to the measurement tip unit.

13. The combustion engine of claim 12, wherein the measurement tip unit comprises:
a measurement tip tube comprising a first end disposed in the combustion space, a second end disposed outside the nozzle casing, and the combustion air passage formed therein;
a locational restriction member provided outside the first end of the measurement tip tube and restricting a location of the first end of the measurement tip tube inserted into the combustion engine; and
a support member coupled to an outer portion of the measurement tip tube while being spaced apart from the locational restriction member, and supporting the measurement tip tube while being in close contact with the nozzle casing,
wherein the plurality of cooling lines are formed at the locational restriction member,
the measurement tip tube is a hollow tube,
the locational restriction member has a cylindrical shape,
an end of the locational restriction member is in close contact with a liner of the combustion engine, and the end includes an inclined end inclined from a circumferential surface of the locational restriction member toward the measurement tip tube, and
the plurality of cooling lines having an inward concave shape are formed on the circumferential surface of the locational restriction member and the inclined end of the locational restriction member.

14. The combustion engine of claim 13, wherein the circumferential surface of the locational restriction member comprises a first section formed at an upstream side with respect to a flow direction of the combustion air and a second section formed at a downstream side with respect to the flow direction of the combustion air,
wherein the plurality of cooling lines are formed within the second section,
the first section has a central angle between 31 and 95 degrees based on a center of the locational restriction member,
the second section includes six cooling lines, and
each cooling line has a semicircular shape, and a radius of each cooling line is equal to or greater than 2.0 mm and less than or equal to 3.0 mm.

15. The combustion engine of claim 14, wherein each cooling line is formed by extending from the locational restriction member to the inclined end, and the cooling lines formed at the inclined end have an angle between 6 and 22 degrees with respect to a shaft direction,
wherein an angle between one cooling line and an adjacent cooling line of the six cooling lines formed within the second section is between 35 degrees and 40 degrees,
wherein the cooling lines are coated with chromium carbide that is a compound consisting of chromium and carbon, and
wherein the locational restriction member is made of a heat-resistant material.

16. The combustion engine of claim 12, further comprising:
a damping unit connecting the measurement tip unit and the measurement unit to each other, and configured to attenuate combustion dynamic pressure of combustion air supplied to the measurement unit; and
a data processing unit connected to the measurement unit, and configured to analyze data of the combustion dynamic pressure measured by the measurement unit, determine operational conditions of the combustion engine, and check abnormal conditions thereof.

17. A gas turbine comprising:
a compressor configured to compress air introduced from an external space;
a combustion engine configured to mix compressed air supplied from the compressor with fuel and to combust the compressed air and the fuel; and
a turbine configured to allow combustion air supplied from the combustion engine to pass through the inner portion thereof to generate power for electric power generation,
wherein the combustion engine comprises:
a nozzle casing;
a liner connected to a turbine-side end portion of the nozzle casing, and comprising a combustion space formed therein and combusting the mixture of the fuel and the compressed air;
a transition piece connected to a turbine-side end portion of the liner, and configured to supply combustion air generated in the combustion space to the turbine; and
a nozzle assembly installed inside the nozzle casing, and injecting the fuel and the compressed air into the combustion space,
wherein the combustion engine comprises a combustion pressure measurement device configured to measure combustion dynamic pressure in the combustion engine,
wherein the combustion pressure measurement device comprises:
a measurement tip unit disposed in the combustion space of the combustion engine, and comprising a combustion air passage formed therein; and
a measurement unit including a pressure sensor and configured to measure combustion dynamic pressure of combustion air supplied through the combustion air passage of the measurement tip unit,
wherein the measurement tip unit comprises a plurality of cooling lines to reduce thermal damage to the measurement tip unit.

18. The gas turbine of claim 17, wherein the measurement tip unit comprises:
a measurement tip tube comprising a first end disposed in the combustion space, a second end disposed outside the nozzle casing, and the combustion air passage formed therein;
a locational restriction member provided outside the first end of the measurement tip tube and restricting a location of the first end of the measurement tip tube inserted into the combustion engine; and
a support member coupled to an outer portion of the measurement tip tube while being spaced apart from the locational restriction member, and supporting the measurement tip tube while in close contact with the nozzle casing,
wherein the plurality of cooling lines are formed at the locational restriction member,
the measurement tip tube is a hollow tube,
the locational restriction member has a cylindrical shape,
an end of the locational restriction member is in close contact with a liner of the combustion engine, and the end includes an inclined end inclined from a circumferential surface of the locational restriction member toward the measurement tip tube,
a plurality of cooling lines having an inward concave shape are formed on the circumferential surface of the locational restriction member and the inclined end of the locational restriction member,
wherein the circumferential surface of the locational restriction member comprises a first section formed at an upstream side with respect to a flow direction of the combustion air and a second section formed at a downstream side with respect to the flow direction of the combustion air,
the plurality of cooling lines are formed within the second section,
the first section has a central angle between 31 and 95 degrees based on a center of the locational restriction member,
the second section includes six cooling lines, and
each cooling line has a semicircular shape, and a radius of each cooling line is equal to or greater than 2.0 mm and less than or equal to 3.0 mm.

19. The gas turbine of claim 18, wherein each cooling line is formed by extending from the locational restriction member to the inclined end, and the cooling lines formed at the inclined end have an angle between 6 and 22 degrees with respect to a shaft direction,
an angle between one cooling line and an adjacent cooling line of the six cooling lines formed within the second section is between 35 degrees and 40 degrees,
the cooling lines are coated with chromium carbide that is a compound consisting of chromium and carbon, and
the locational restriction member is made of a heat-resistant material.

20. The gas turbine of claim 17, further comprising:
a damping unit connecting the measurement tip unit and the measurement unit to each other, and configured to attenuate combustion dynamic pressure of combustion air supplied to the measurement unit; and
a data processing unit connected to the measurement unit, and configured to analyze data of the combustion dynamic pressure measured by the measurement unit, determine operational conditions of the combustion engine, and check abnormal conditions thereof.
